(19) United States
(12) Patent Application Publication
(10) Pub. No.: US 2024/0365770 A1
(43) Pub. Date: Nov. 7, 2024

(54) MINNOW TRAP AND BAIT ASSEMBLY

(71) Applicant: Steven Fowler, Woodbury, VT (US)

(72) Inventor: Steven Fowler, Woodbury, VT (US)

(21) Appl. No.: 18/142,265

(22) Filed: May 2, 2023

(51) Int. Cl. A01M 23/08

(52) U.S. Cl. CPC A01M 23/08

(57) ABSTRACT

A minnow trap and bait assembly for luring minnows using bait held in a container within the minnow trap includes a frame including a boundary wall having an exterior surface and an interior surface. A pair of funnels is coupled to the frame and each of the funnels extend into the frame wherein each of the funnels provides access for minnows into the frame. A bait container is positioned within the frame and encloses a compartment space containing minnow bait. An outer surface of the bait container has a container opening extending therethrough and into the compartment space, and a lid removably closes the container opening of the compartment space of the bait container. A securing member couples the bait container to the frame within the interior space.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to minnow traps and more particularly pertains to a new minnow trap for luring minnows using bait held in a container within the minnow trap.

### (2) Description of Related Art Including Information Disclosed Under 37 CFR 1.97 and 1.98

The prior art relates to minnow traps and includes a variety of minnow traps comprising a basket having openings into the basket that are sized for a minnow to swim through. Known prior art does not include a hinged compartment being positioned within the basket and being configured to store bait such that the bait lures minnows into the basket.

### BRIEF SUMMARY OF THE INVENTION

An embodiment of the disclosure meets the needs presented above by generally comprising a frame enclosing an interior space. The frame includes a boundary wall having an exterior surface and an interior surface. A pair of funnels is coupled to the frame and each of the funnels extend into the interior space wherein each of the funnels is configured to provide access for minnows into the interior space of the frame. A bait container is positioned within the interior space of the frame and encloses a compartment space configured to contain minnow bait. An outer surface of the bait container has a container opening extending therethrough and into the compartment space, and a lid removably closes the container opening of the compartment space of the bait container. The lid is pivotally attached to the bait container and is pivotally positionable from an open position wherein access is permitted through the container opening to a closed position wherein access is inhibited through the container opening. A securing member couples the bait container to the frame within the interior space.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a minnow trap and bait assembly according to an embodiment of the disclosure.

FIG. 2 is a side exploded view of an embodiment of the disclosure.

FIG. 3 is a front view of an embodiment of the disclosure.

FIG. 4 is a cross-sectional view of an embodiment of the disclosure taken along Line 4-4 of FIG. 2.

FIG. 5 is a top view of an embodiment of the disclosure.

FIG. 6 is a detail open view of an embodiment of the disclosure.

FIG. 7 is a detail exploded view of an embodiment of the disclosure.

### DETAILED DESCRIPTION OF THE INVENTION

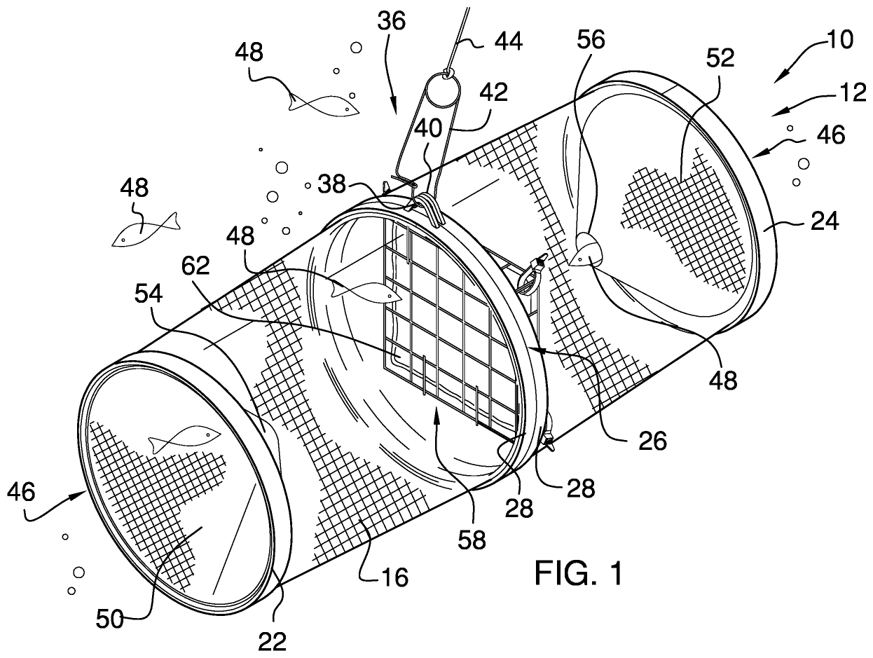

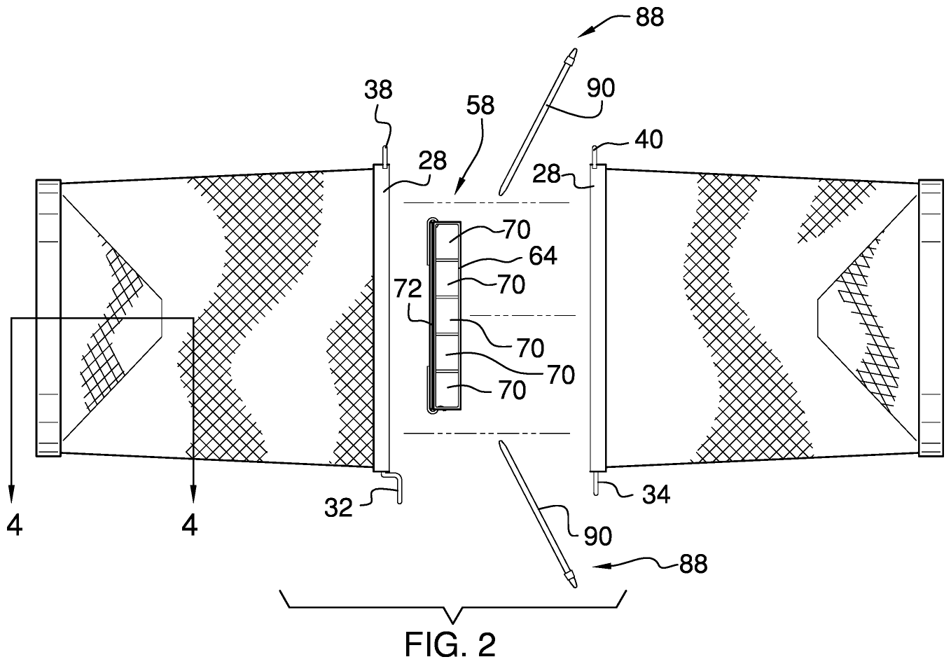

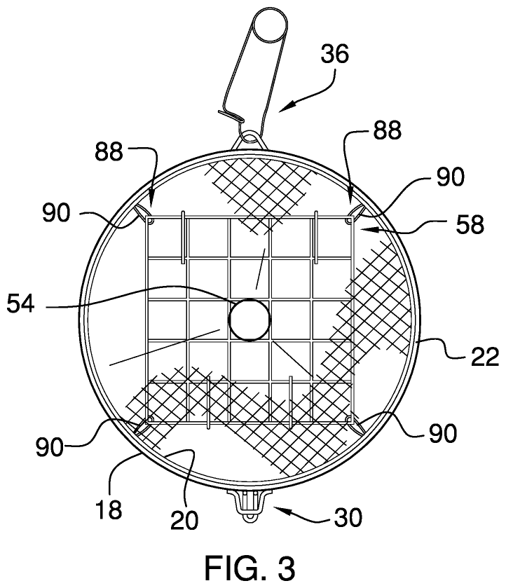

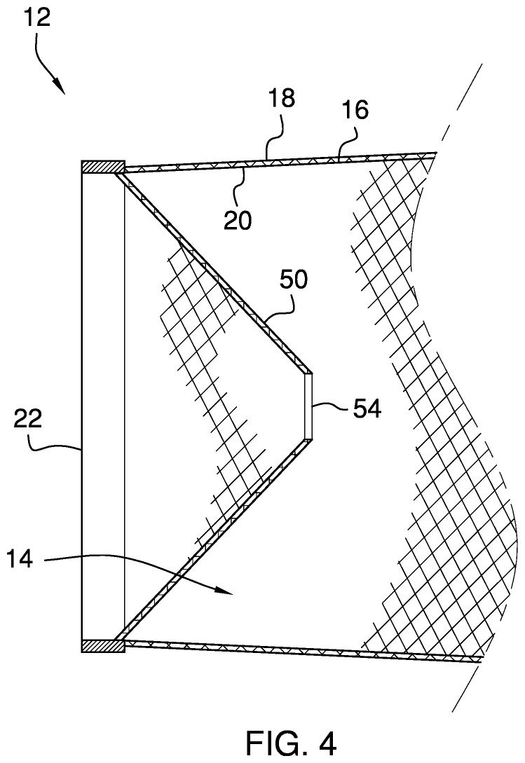

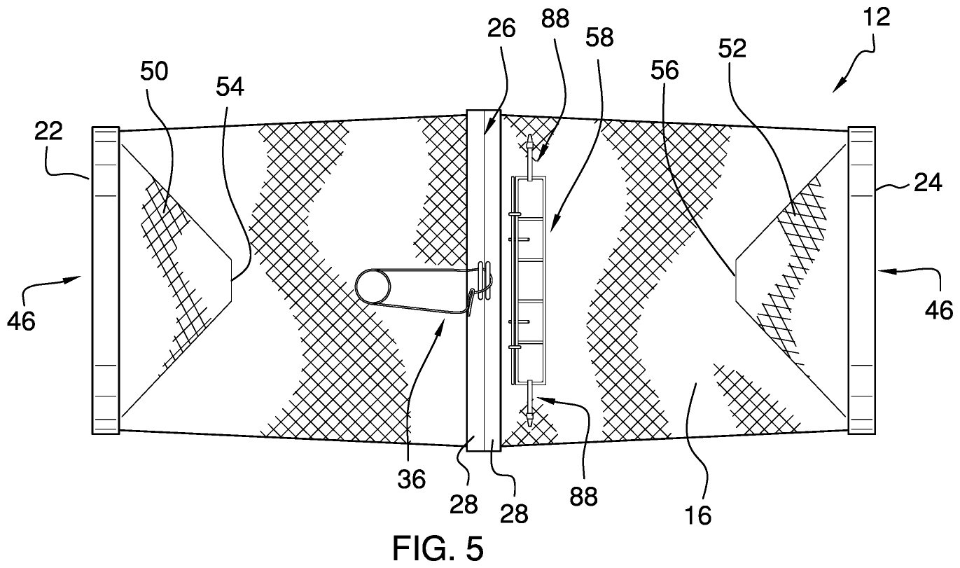

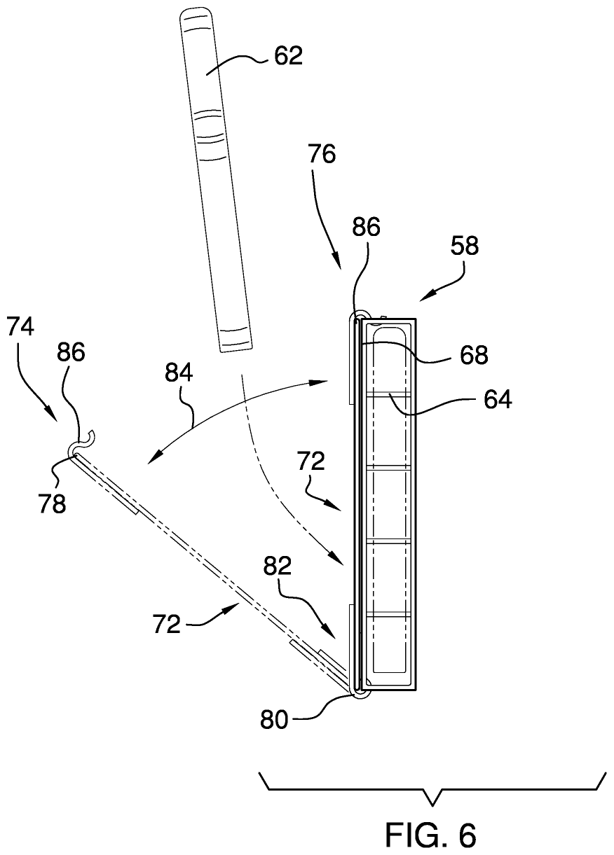

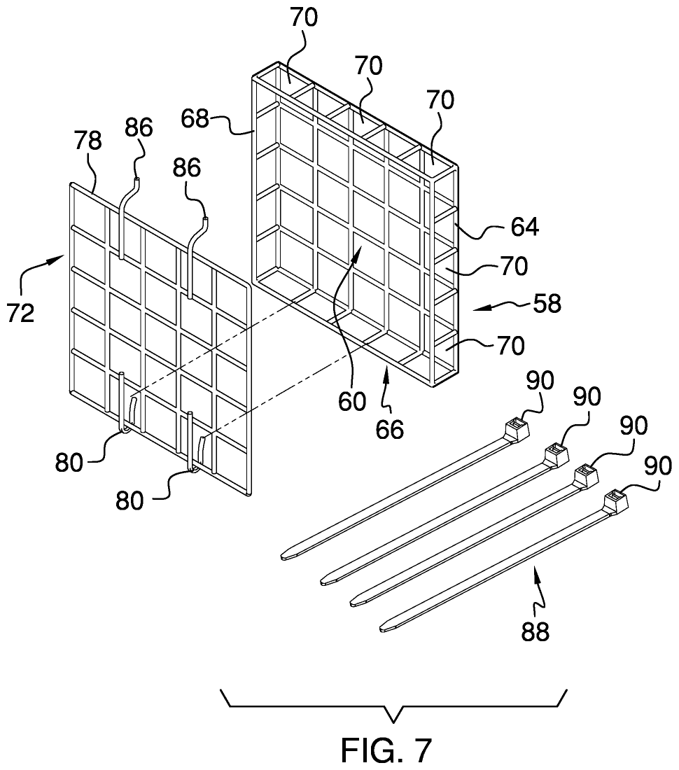

With reference now to the drawings, and in particular to FIGS. 1 through 7 thereof, a new minnow trap embodying the principles and concepts of an embodiment of the disclosure and generally designated by the reference numeral 10 will be described.

As best illustrated in FIGS. 1 through 7, the minnow trap and bait assembly 10 generally comprises a frame 12 enclosing an interior space 14. The frame 12 includes a boundary wall 16 having an exterior surface 18 and an interior surface 20. The boundary wall 16 includes a first boundary edge 22 and a second boundary edge 24. The boundary wall 16 has a cylindrical configuration, wherein the first boundary edge 22 and the second boundary edge 24 each are circular. The boundary wall 16 is perforated wherein the frame 12 is configured to fill with water when the frame 12 is submerged into the water. The boundary wall 16 typically comprises a plurality of wires woven together.

The frame 12 has a slit 26 extending through the exterior surface 18 and through the interior surface 20, and the slit 26 is equally spaced between the first boundary edge 22 and the second boundary edge 24. The slit 26 forms a pair of parallel edges 28 removably abutting each other. The parallel edges 28 are selectively moveable apart from each other to allow access into the interior space 14 of the frame 12. A clasp 30 releasably secures a bottom section of each of the parallel edges 28 to each other. The clasp 30 includes a first clasp member 32 and a second clasp member 34 each being attached to the bottom section of one of the parallel edges 28, wherein the first clasp member 32 and the second clasp member 34 interlock with each other to secure the bottom section of each of the parallel edges 28 to each other.

A fishing line fastener 36 is attached to the frame 12 and secures a top section of each of the parallel edges 28 to each other. The fishing line fastener 36 includes a first loop 38 and a second loop 40 each attached to the top section of one of the pair of parallel edges 28. A clip 42 of the fishing line fastener 36 secures the first loop 38 to the second loop 40, wherein the clip 42 secures the top section of each of the parallel edges 28 to each other. The clip 42 of the fishing line fastener 36 is configured to tie to a fishing line 44.

A pair of funnels 46 is coupled to the frame 12. Each of the funnels 46 extends into the interior space 14 wherein each of the funnels 46 is configured to provide access for minnows 48 to swim into the interior space 14 of the frame 12. The pair of funnels 46 includes a first funnel 50 coupled to the first boundary edge 22 and a second funnel 52 coupled to the second boundary edge 24. The first boundary edge 22 defines a first funnel wide opening of the first funnel 50 and the second boundary edge 24 defines a second funnel wide opening of the second funnel 52. The first funnel 50 tapers from the first boundary edge 22 towards a first perimeter edge 54, wherein the first perimeter edge defines a first funnel narrow opening of the first funnel 50. The second funnel 52 tapers from the second boundary edge 24 towards a second perimeter edge 56, wherein the second perimeter edge defines a second funnel narrow opening of the second funnel 52. The first and second narrow openings are positioned within the interior space 14 of the frame 12.

A bait container 58 is positioned within the interior space 14 of the frame 12. The bait container 58 encloses a compartment space 60 configured to contain minnow bait 62 such as bread. An outer surface 64 of the bait container 58 has a container opening 66 extending therethrough and into the compartment space 60, and the container opening 66 forms a peripheral edge 68. The bait container 58 has a rectangular configuration, and the outer surface 64 of the bait container 58 has a plurality of apertures 70 extending therethrough, wherein the bait container 58 is configured to feed minnows 48 accessing minnow bait 62 within the compartment space 60 through the apertures 70.

A lid 72 removably closes the container opening 66 of the compartment space 60 of the bait container 58. The lid 72 is pivotally attached to the bait container 58 and is pivotally positionable from an open position 74 wherein access is permitted through the container opening 66 to a closed position 76 wherein access is inhibited through the container opening 66. The lid 72 has an outer edge 78 coupled to the peripheral edge 68 of the bait container 58 by a hinge 80. The closed position 76 is defined by the outer edge 78 abutting the peripheral edge 68 of the bait container 58, wherein the open position 74 is defined by a section of the outer edge 78 forming a junction 82 with a section of the peripheral edge 68 wherein a gap 84 is formed between the outer edge 78 and the peripheral edge 68 outside of the junction 82. A latch 86 is attached to the lid 72, and the latch 86 releasably secures to the lid 72 in a closed position 76 by attaching to the bait container 58.

A securing member 88 couples the bait container 58 to the frame 12 within the interior space 14. The securing member 88 comprises a plurality of tethers 90 attaching the bait container 58 to the boundary wall 16 of the frame 12. Each of the tethers 90 comprises a cable tie configured to form a loop, wherein a portion of the bait container 58 and the boundary wall 16 each are looped within a cable tie.

In use, the lid 72 of the bait container 58 is positioned to the open position 74 prior to inserting minnow bait 62 in the compartment space 60. The lid 72 of the bait container 58 is positioned to the closed position 76 thereafter to secure minnow bait 62 within the bait container 58. The fishing line fastener 36 may be tied to the fishing line 44 prior to submerging the frame 12 within water. The frame 12 is removed from the water after accumulating minnows 48 in the interior space 14 of the frame 12. The frame 12 may be removed by pulling upwardly on the fishing line 44 wherein the fishing line 44 pulls the frame 12 upwardly from the water.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A minnow trapping assembly comprising:
a frame enclosing an interior space, said frame including a boundary wall having an exterior surface and an interior surface;
a pair of funnels being coupled to said frame, each of said funnels extending into said interior space wherein each of said funnels is configured to provide access for minnows to swim into said interior space of said frame;
a bait container being positioned within said interior space of said frame, said bait container enclosing a compartment space configured to contain minnow bait, an outer surface of said bait container having a container opening extending therethrough and into said compartment space;
a lid removably closing said container opening of said compartment space of said bait container, said lid being pivotally attached to said bait container and being pivotally positionable from an open position wherein access is permitted through said container opening to a closed position wherein access is inhibited through said container opening;
a securing member coupling said bait container to said frame within said interior space.

2. The minnow trapping assembly of claim 1, wherein said boundary wall includes a first boundary edge and a second boundary edge, said boundary wall having a cylindrical configuration, wherein said first boundary edge and said second boundary edge each are circular.

3. The minnow trapping assembly of claim 1, wherein said boundary wall is perforated wherein said frame is configured to fill with water when the frame is submerged into the water.

4. The minnow trapping assembly of claim 2, wherein said frame has a slit extending through said exterior surface and through said interior surface, said slit being equally spaced between said first boundary edge and said second boundary edge, said slit forming a pair of parallel edges, said pair of parallel edges removably abutting each other, a clasp releasably securing a bottom section of each of said parallel edges to each other, a fishing line fastener being attached to said frame and securing a top section of each of said parallel edges to each other.

5. The minnow trapping assembly of claim 2, wherein said pair of funnels includes a first funnel coupled to said first boundary edge and a second funnel coupled to said second boundary edge, said first boundary edge defining a first funnel wide opening of said first funnel and said second boundary edge defining a second funnel wide opening of said second funnel, said first funnel tapering from said first boundary edge towards a first perimeter edge, wherein said first perimeter edge defines a first funnel narrow opening of said first funnel, said second funnel tapering from said second boundary edge towards a second perimeter edge, wherein said second perimeter edge defines a second funnel narrow opening of said second funnel, said first and second narrow openings being positioned within said interior space of said frame.

6. The minnow trapping assembly of claim 1, wherein said container opening forms a peripheral edge, said bait container having a rectangular configuration, said outer surface of said bait container having a plurality of apertures extending therethrough, wherein said bait container is configured to feed minnows accessing minnow bait within said compartment space through said apertures.

7. The minnow trapping assembly of claim 6, wherein said lid has an outer edge being coupled to said peripheral edge of said bait container by a hinge, said closed position being defined by said outer edge abutting said peripheral edge of said bait container, wherein said open position is defined by a section of said outer edge forming a junction with a section of said peripheral edge wherein a gap is formed between said outer edge and said peripheral edge outside of said junction.

8. The minnow trapping assembly of claim 7, wherein said securing member comprises a plurality of tethers attaching said bait container to said boundary wall of said frame, each of said tethers comprising a cable tie configured to form a loop, wherein a portion of said bait container and said boundary wall each are looped within said cable ties.

9. A minnow trapping assembly comprising:
a frame enclosing an interior space, said frame including a boundary wall having an exterior surface and an interior surface, said boundary wall including a first boundary edge and a second boundary edge, said boundary wall having a cylindrical configuration, wherein said first boundary edge and said second boundary edge each are circular, said boundary wall being perforated wherein said frame is configured to fill with water when the frame is submerged into the water, said frame having a slit extending through said exterior surface and through said interior surface, said slit being equally spaced between said first boundary edge and said second boundary edge, said slit forming a pair of parallel edges, said pair of parallel edges removably abutting each other, a clasp releasably securing a bottom section of each of said parallel edges to each other, a fishing line fastener being attached to said frame and securing a top section of each of said parallel edges to each other;
a pair of funnels being coupled to said frame, each of said funnels extending into said interior space wherein each of said funnels is configured to provide access for minnows to swim into said interior space of said frame, said pair of funnels including a first funnel coupled to said first boundary edge and a second funnel coupled to said second boundary edge, said first boundary edge defining a first funnel wide opening of said first funnel and said second boundary edge defining a second funnel wide opening of said second funnel, said first funnel tapering from said first boundary edge towards a first perimeter edge, wherein said first perimeter edge defines a first funnel narrow opening of said first funnel, said second funnel tapering from said second boundary edge towards a second perimeter edge, wherein said second perimeter edge defines a second funnel narrow opening of said second funnel, said first and second narrow openings being positioned within said interior space of said frame;
a bait container being positioned within said interior space of said frame, said bait container enclosing a compartment space configured to contain minnow bait, an outer surface of said bait container having a container opening extending therethrough and into said compartment space, said container opening forming a peripheral edge, said bait container having a rectangular configuration, said outer surface of said bait container having a plurality of apertures extending therethrough, wherein said bait container is configured to feed minnows accessing minnow bait within said compartment space through said apertures;
a lid removably closing said container opening of said compartment space of said bait container, said lid being pivotally attached to said bait container and being pivotally positionable from an open position wherein access is permitted through said container opening to a closed position wherein access is inhibited through said container opening, said lid having an outer edge being coupled to said peripheral edge of said bait container by a hinge, said closed position being defined by said outer edge abutting said peripheral edge of said bait container, wherein said open position is defined by a section of said outer edge forming a junction with a section of said peripheral edge wherein a gap is formed between said outer edge and said peripheral edge outside of said junction;
a securing member coupling said bait container to said frame within said interior space, said securing member comprising a plurality of tethers attaching said bait container to said boundary wall of said frame, each of said tethers comprising a cable tie configured to form a loop, wherein a portion of said bait container and said boundary wall each are looped within said cable ties.
